(19) United States
(12) Patent Application Publication
(10) Pub. No.: US 2015/0226999 A1
(43) Pub. Date: Aug. 13, 2015

(54) OPTICAL MEMBER, POLARIZING PLATE SET, AND LIQUID CRYSTAL DISPLAY DEVICE

(71) Applicant: NITTO DENKO CORPORATION, Ibaraki-shi, Osaka (JP)

(72) Inventors: Takehito Fuchida, Ibaraki-shi (JP); Shouhei Maezawa, Ibaraki-shi (JP); Kozo Nakamura, Ibaraki-shi (JP); Hiroyuki Takemoto, Ibaraki-shi (JP); Nao Murakami, Ibaraki-shi (JP)

(73) Assignee: NITTO DENKO CORPORATION, Ibaraki-shi, Osaka (JP)

(21) Appl. No.: 14/426,498

(22) PCT Filed: Sep. 9, 2013
(86) PCT No.: PCT/JP2013/074201

§ 371 Date: Mar. 6, 2015

(30) Foreign Application Priority Data
Sep. 13, 2012 (JP) 2012-201861
Apr. 26, 2013 (JP) 2013-093803
Sep. 5, 2013 (JP) 2013-183959

(51) Int. Cl. G02F 1/1335; G02B 5/30; G02B 5/02

(52) U.S. Cl. CPC G02F 1/133504; G02B 5/0242; G02B 5/0231; G02B 5/3025; G02F 1/133536; G02F 2001/133507

(57) ABSTRACT

There is provided an optical member that suppresses the occurrence of moire and glare, and can realize a liquid crystal display apparatus that is excellent in mechanical strength and has high brightness. An optical member according to an embodiment of the present invention includes: a polarizing plate; a light-diffusing pressure-sensitive adhesive layer; a reflective polarizer; and a prism sheet. A volume-average particle diameter of light-diffusible fine particles in the light-diffusing pressure-sensitive adhesive layer is from 1 μm to 4 μm; and a refractive index of a pressure-sensitive adhesive in the light-diffusing pressure-sensitive adhesive layer is 1.47 or more.

### TECHNICAL FIELD

The present invention relates to an optical member, a polarizing plate set, and a liquid crystal display apparatus. More specifically, the present invention relates to an optical member including a polarizing plate, a light-diffusing pressure-sensitive adhesive layer, a reflective polarizer, and a prism sheet, and a polarizing plate set and a liquid crystal display apparatus each using the optical member.

### BACKGROUND ART

In recent years, as a display, a liquid crystal display apparatus using a surface light source device has been remarkably widespread. In a liquid crystal display apparatus including an edge light-type surface light source device, for example, light emitted from a light source enters a light guide plate, and propagates through an inside of the light guide plate while repeating a total reflection on a light output surface (liquid crystal cell-side surface) of the light guide plate and a back surface thereof. A part of the light that propagates through the inside of the light guide plate allows a traveling direction thereof to be changed by a light scattering body or the like, which is provided on the back surface of the light guide plate or the like, and is output from the light output surface to an outside of the light guide plate. Such light output from the light output surface of the light guide plate is diffused and condensed by various optical sheets such as a diffusion sheet, a prism sheet, a brightness enhancement film, or the like, and thereafter, the light enters a liquid crystal display panel in which polarizing plates are arranged on both sides of a liquid crystal cell. Liquid crystal molecules of a liquid crystal layer of the liquid crystal cell are driven for each of pixels to control transmission and absorption of the incident light. As a result, an image is displayed.

Typically, the above-mentioned prism sheet is fitted into a casing of the surface light source device, and is provided close to the light output surface of the light guide plate. In a liquid crystal display apparatus using such a surface light source device as described above, the prism sheet and the light guide plate are rubbed against each other when installing the prism sheet or under an actual usage environment, and the light guide plate is flawed in some cases. In order to solve such a problem, a technology for integrating the prism sheet with a light source-side polarizing plate is proposed (Patent Literature 1). However, a liquid crystal display apparatus using such polarizing plate with which the prism sheet is integrated has a problem of being dark because front brightness is insufficient.

Further, a liquid crystal display apparatus using such surface light source device as described above involves a problem in that moire occurs owing to the regular structure of the prism sheet. To solve such problem, it has been proposed that the prism sheet be provided with a light diffusion layer. However, the use of a light diffusion layer having light diffusibility strong enough to dissolve the moire causes a problem in that the brightness of the liquid crystal display apparatus reduces. For example, Patent Literature 2 discloses (1) an optical member obtained by laminating a light-diffusible pressure-sensitive adhesive on one side of a polarizing plate and laminating a sheet member having a prism shape on the other side thereof, and (2) an optical member obtained by laminating a polarizing plate and a sheet member having a prism shape through a light-diffusible pressure-sensitive adhesive. Although the optical member of the item (1) can suppress the occurrence of the moire, the brightness and front contrast of the liquid crystal display apparatus become insufficient. The optical member of the item (2) cannot suppress the occurrence of the moire and makes the brightness of the liquid crystal display apparatus insufficient. In addition, along with an increase in definition of the liquid crystal cell, there arises a problem in that glare occurs in the light diffusion layer and hence the visibility of the apparatus is impaired.

### CITATION LIST

### Patent Literature

[PTL 1] JP 2011-123476 A

### SUMMARY OF INVENTION

### Technical Problem

The present invention has been made to solve the above-mentioned problems, and an object of the present invention is to provide an optical member that suppresses the occurrence of moire and glare, and can realize a liquid crystal display apparatus that is excellent in mechanical strength and has high brightness.

### Solution to Problem

An optical member according to an embodiment of the present invention includes: a polarizing plate; a light-diffusing pressure-sensitive adhesive layer; a reflective polarizer; and a prism sheet. A volume-average particle diameter of light-diffusible fine particles in the light-diffusing pressure-sensitive adhesive layer is from 1 μm to 4 μm; and a refractive index of a pressure-sensitive adhesive in the light-diffusing pressure-sensitive adhesive layer is 1.47 or more.

In one embodiment of the present invention, the light-diffusing pressure-sensitive adhesive layer has a haze value of from 80% to 95%.

In one embodiment of the present invention, the pressure-sensitive adhesive contains a (meth)acrylic polymer containing an alkyl(meth)acrylate, an aromatic ring-containing (meth)acrylic monomer, a carboxyl group-containing monomer, and a hydroxyl group-containing monomer as monomer units.

In one embodiment of the present invention, an air layer is absent between the polarizing plate and the prism sheet.

In one embodiment of the present invention, the optical member includes a polarizing plate integrated with the prism sheet.

According to another aspect of the present invention, there is provided a polarizing plate set. The polarizing plate set includes the above-described optical member to be used as a back surface side polarizing plate; and a viewer side polarizing plate.

According to another aspect of the present invention, there is provided a liquid crystal display apparatus. The liquid crystal display apparatus includes a liquid crystal cell; a polarizing plate arranged on a viewer side of the liquid crystal cell; and the above-described optical member arranged on a side of the liquid crystal cell opposite to the viewer side. A distance between opposing black matrices in one pixel of the liquid crystal cell is 200 μm or less.

### Advantageous Effects of Invention

According to an embodiment of the present invention, in the optical member including the polarizing plate, the light-diffusing pressure-sensitive adhesive layer, the reflective polarizer, and the prism sheet, the volume-average particle diameter of the light-diffusible fine particles in the light-diffusing pressure-sensitive adhesive layer and the refractive index of the pressure-sensitive adhesive in the light-diffusing pressure-sensitive adhesive layer are optimized. Thus, the optical member suppresses the occurrence of moire and glare, and can realize a liquid crystal display apparatus having high brightness. Further, the polarizing plate and the prism sheet are integrated, and hence the optical member according to an embodiment of the present invention can realize a liquid crystal display apparatus excellent in mechanical strength.

### BRIEF DESCRIPTION OF DRAWINGS

FIG. 1 is a schematic sectional view illustrating an optical member according to one embodiment of the present invention.

FIG. 2 is a schematic perspective view of an example of a reflective polarizer that can be used in the optical member of the present invention.

FIG. 3 is an exploded perspective view of the optical member of FIG. 1.

FIG. 4 is a schematic sectional view illustrating a liquid crystal display apparatus according to one embodiment of the present invention.

FIGS. 5(a) and 5(b) are each a schematic sectional view illustrating the aligned state of a liquid crystal molecule in a VA mode.

### DESCRIPTION OF EMBODIMENTS

Preferred embodiments of the present invention are hereinafter described with reference to the drawings. However, the present invention is not limited to these embodiments.

A. Entire Construction of Optical Member

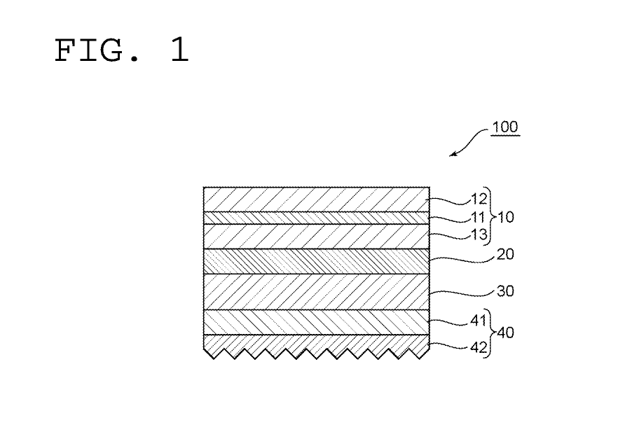

FIG. 1 is a schematic sectional view illustrating an optical member according to one embodiment of the present invention. An optical member 100 includes a polarizing plate 10, alight-diffusing pressure-sensitive adhesive layer 20, a reflective polarizer 30, and a prism sheet 40. The polarizing plate 10 typically includes a polarizer 11, a protective layer 12 arranged on one side of the polarizer 11, and a protective layer 13 arranged on the other side of the polarizer 11. The prism sheet 40 typically includes a base portion 41 and a prism portion 42. The polarizing plate and the prism sheet are integrated as described above, and hence an air layer between the prism sheet and the polarizing plate can be excluded, which can contribute to the thinning of a liquid crystal display apparatus. The thinning of the liquid crystal display apparatus has a high commercial value because the thinning widens the selection of design. Further, the polarizing plate and the prism sheet are integrated, and hence a flaw in the prism sheet due to rubbing upon attachment of the prism sheet to a surface light source apparatus (a backlight unit, substantially a light guide plate) can be avoided. Accordingly, a liquid crystal display apparatus that can prevent the cloudiness of its display resulting from such flaw and is excellent in mechanical strength can be obtained. In addition, according to this embodiment, the reflective polarizer 30 is arranged between the light-diffusing pressure-sensitive adhesive layer 20 and the prism sheet 40, and a predetermined distance is provided between the light-diffusing pressure-sensitive adhesive layer 20 and the prism sheet 40, and hence a liquid crystal display apparatus that suppresses the occurrence of moire and has high brightness can be realized. In addition, according to this embodiment, the light-diffusing pressure-sensitive adhesive layer 20 is arranged on the side of the reflective polarizer 30 opposite to the prism sheet 40 (when the optical member is used in a liquid crystal display apparatus, the layer is arranged on a side opposite to the backlight unit of the liquid crystal display apparatus), and hence the brightness of the apparatus can be improved. Specifically, in the reflective polarizer, the utilization efficiency of front incident light is higher than that of incident light in an oblique direction. The light-diffusing pressure-sensitive adhesive layer 20 is arranged on the side of the reflective polarizer 30 opposite to the prism sheet 40, and hence the quantity of the front incident light can be increased. As a result, the utilization efficiency of the light can be additionally improved and hence the brightness can be improved.

In an embodiment of the present invention, the volume-average particle diameter of light-diffusible fine particles in the light-diffusing pressure-sensitive adhesive layer is from 1 μm to 4 μm, and the refractive index of a pressure-sensitive adhesive in the light-diffusing pressure-sensitive adhesive layer is 1.47 or more. When the volume-average particle diameter of the light-diffusible fine particles and the refractive index of the pressure-sensitive adhesive fall within such ranges, the occurrence of the glare of the light-diffusing pressure-sensitive adhesive layer in association with an increase in definition of a liquid crystal cell can be suppressed. It should be noted that details about the volume-average particle diameter of the light-diffusible fine particles and the refractive index of the pressure-sensitive adhesive are described in the section C to be described later.

The components of the optical member are hereinafter described in detail.

B. Polarizing Plate

The polarizing plate 10 typically includes the polarizer 11, the protective layer 12 arranged on one side of the polarizer 11, and the protective layer 13 arranged on the other side of the polarizer 11. The polarizer is typically an absorption-type polarizer.

B-1. Polarizer

The transmittance of the above-mentioned absorption-type polarizer (also referred to as a single axis transmittance) at the wavelength of 589 nm is preferably 41% or more, more preferably 42% or more. Note that, the theoretical upper limit of the single axis transmittance is 50%. In addition, polarization degree thereof is preferably from 99.5% to 100%, more preferably from 99.9% to 100%. As long as the single axis transmittance and the polarization degree fall within the range, contrast in the front direction can be further higher when used in the liquid crystal display apparatus.

The single axis transmittance and polarization degree described above can be measured with a spectrophotometer. A specific measurement method for the polarization degree may involve measuring parallel transmittance (H₀) and perpendicular transmittance (H₉₀) of the polarizer, and determining the polarization degree through the following expression: polarization degree (%)={(H₀−H₉₀)/(H₀+H₉₀)}^{1/2}×100. The parallel transmittance (H₀) refers to a value of transmittance of a parallel-type laminated polarizer prepared by causing two identical polarizers to overlap with each other in such a manner that absorption axes thereof are parallel to each other. In addition, the perpendicular transmittance (H₉₀) refers to a value of a transmittance of a perpendicular-type laminated polarizer prepared by causing two identical polarizers to overlap with each other in such a manner that absorption axes thereof are perpendicular to each other. Note that, each transmittance is a Y value obtained through relative spectral responsivity correction at a two-degree field of view (C light source) in JIS Z 8701-1982.

Any appropriate polarizer may be adopted as the absorption-type polarizer depending on purpose. Examples thereof include a polarizer obtained by causing a hydrophilic polymer film such as a polyvinyl alcohol-based film, a partially formalized polyvinyl alcohol-based film, or an ethylene-vinyl acetate copolymer-based partially saponified film to absorb a dichroic substance such as iodine or a dichroic dyestuff, followed by uniaxial stretching, and a polyene-based alignment film such as a product obtained by subjecting polyvinyl alcohol to dehydration treatment or a product obtained by subjecting polyvinyl chloride to dehydrochlorination treatment. In addition, there may also be used, for example, guest-host-type E-type and O-type polarizers each including a dichroic substance and a liquid crystalline compound in which the liquid crystalline compound is aligned in a fixed direction as disclosed in, for example, U.S. Pat. No. 5,523,863, and E-type and O-type polarizers in which the lyotropic liquid crystals are aligned in a fixed direction as disclosed in, for example, U.S. Pat. No. 6,049,428.

Of such polarizers, a polarizer formed of a polyvinyl alcohol (PVA)-based film containing iodine is suitably used from the viewpoint of having a high polarization degree. The polyvinyl alcohol or a derivative thereof is used as a material for the polyvinyl alcohol-based film to be applied to the polarizer. Examples of the derivative of polyvinyl alcohol include polyvinyl formal and polyvinyl acetal as well as polyvinyl alcohol modified with, for example, an olefin such as ethylene or propylene, an unsaturated carboxylic acid such as acrylic acid, methacrylic acid, or crotonic acid, alkyl ester thereof, or acrylamide. Polyvinyl alcohol having a polymerization degree of about from 1,000 to 10,000 and a saponification degree of about from 80 mol % to 100 mol % are generally used.

The polyvinyl alcohol-based film (unstretched film) is subjected to at least uniaxial stretching treatment and iodine dyeing treatment according to conventional methods, and may further be subjected to boric acid treatment or iodine ion treatment. In addition, the polyvinyl alcohol-based film (stretched film) subjected to the treatment described above becomes a polarizer through drying according to a conventional method.

The stretching method in the uniaxial stretching treatment is not particularly limited, and any one of a wet stretching method and a dry stretching method may be adopted. As a stretching means for the dry stretching method, there is given, for example, a roll stretching method, a heating roll stretching method, or a compression stretching method. The stretching may be performed in a plurality of steps. In the stretching means, the unstretched film is generally in a heated state. A film having a thickness of about from 30 μm to 150 μm is generally used as the unstretched film. The stretching ratio of the stretched film may be appropriately set depending on purpose. However, the stretching ratio (total stretching ratio) is about from 2 times to 8 times, preferably from 3 times to 6.5 times, more preferably from 3.5 times to 6 times. The thickness of the stretched film is suitably about from 5 μm to 40 μm.

The iodine dyeing treatment is performed by immersing the polyvinyl alcohol-based film in an iodine solution containing iodine and potassium iodide. The iodine solution is generally an iodine aqueous solution, and contains iodine and potassium iodide as a dissolution aid. The concentration of iodine is preferably about from 0.01 wt % to 1 wt %, more preferably from 0.02 wt % to 0.5 wt %, and the concentration of potassium iodide is preferably about from 0.01 wt % to 10 wt %, more preferably from 0.02 wt % to 8 wt %.

In iodine dyeing treatment, the temperature of the iodine solution is generally about from 20° C. to 50° C., and is preferably from 25° C. to 40° C. Time period of the immersion falls within a range of generally about from 10 seconds to 300 seconds, and is preferably from 20 seconds to 240 seconds. In iodine dyeing treatment, through adjustment of conditions such as the concentration of the iodine solution, and the immersion temperature and time period of the immersion of polyvinyl alcohol-based film into the iodine solution, iodine content and potassium content in the polyvinyl alcohol-based film is adjusted so as to allow both to fall within a desires range. The iodine dyeing treatment may be performed at any one of the time points before the uniaxial stretching treatment, during the uniaxial stretching treatment, and after the uniaxial stretching treatment.

The boric acid treatment is performed by immersing the polyvinyl alcohol-based film in a boric acid aqueous solution. The concentration of boric acid in the boric acid aqueous solution is about from 2 wt % to 15 wt %, preferably from 3 wt % to 10 wt %. Potassium iodide, potassium ion and iodine ion may be incorporated in the boric acid aqueous solution. The concentration of potassium iodide in the boric acid aqueous solution is about from 0.5 wt % to 10 wt %, and is preferably from 1 wt % to 8 wt %. A polarizer with low coloration, that is, almost constant absorbance over approximately entire wavelength region of visible light, so-called neutral grey can be obtained with a boric acid aqueous solution containing potassium iodide.

For example, an aqueous solution obtained by incorporating iodine ion with, for example, potassium iodide is used for the iodine ion treatment. The concentration of potassium iodide is preferably about from 0.5 wt % to 10 wt %, more preferably from 1 wt % to 8 wt %. In iodine ion immersion treatment, the temperature of the aqueous solution is generally about from 15° C. to 60° C., and is preferably from 25° C. to 40° C. Time period of the immersion is generally about from 1 second to 120 seconds, and preferably falls within a range of from 3 seconds to 90 seconds. The time point of the iodine ion treatment is not particularly limited as long as the time point is before the drying step. The treatment may be performed after water washing described later.

The polyvinyl alcohol-based film (stretched film) subjected to the treatment described above may be subjected to a water washing step and a drying step according to a conventional method.

Any appropriate drying method such as natural drying, drying by blowing, or drying by heating may be adopted as the drying step. In the case of the drying by heating, for example, drying temperature thereof is typically from 20° C. to 80° C., and is preferably from 25° C. to 70° C. Time period of the drying is preferably about from 1 minute to 10 minutes. In addition, the moisture content of the polarizer after the drying is preferably from 10 wt % to 30 wt %, more preferably from 12 wt % to 28 wt %, still more preferably from 16 wt % to 25 wt %. When the moisture content is excessively high, in drying the polarizing plate, the polarization degree is liable to decrease in accordance with the drying of the polarizer. In particular, the perpendicular transmittance in a short wavelength region of 500 nm or less is increased, that is, the black display is liable to be colored with blue because of the leakage of the short wavelength light. On the contrary, when the moisture content of the polarizer is excessively small, a problem such as local uneven defect (knick defect) may easily occur.

The polarizing plate 10 is typically provided in a long shape (e.g., a roll shape) and used in the production of an optical member. In one embodiment, the polarizer has an absorption axis in its lengthwise direction. Such polarizer can be obtained by a production method that has been conventionally employed in the industry (e.g., such production method as described above). In another embodiment, the polarizer has the absorption axis in its widthwise direction. The optical member of the present invention can be produced by laminating such polarizer together with a reflective polarizer of a linearly polarized light separation type having a reflection axis in its widthwise direction according to the so-called roll-to-roll process, and hence the efficiency of the production can be significantly improved.

B-2. Protective Layer

The protective layer is formed of any appropriate film that may be used as a protective film for the polarizer. Specific examples of a material serving as a main component of the film include transparent resins such as a cellulose-based resin such as triacetylcellulose (TAC), a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, a (meth)acrylic resin, and an acetate-based resin. Another example thereof is a thermosetting resin or a UV-curable resin such as a (meth)acrylic resin, a urethane-based resin, a (meth)acrylic urethane-based resin, an epoxy-based resin, or a silicone-based resin. Still another example thereof is a glassy polymer such as a siloxane-based polymer. Further, a polymer film described in JP 2001-343529 A (WO 01/37007 A1) may also be used. As a material for the film, for example, there may be used a resin composition containing a thermoplastic resin having a substituted or unsubstituted imide group in a side chain and a thermoplastic resin having a substituted or unsubstituted phenyl group and a nitrile group in a side chain. An example thereof is a resin composition containing an alternate copolymer formed of isobutene and N-methylmaleimide and an acrylonitrile-styrene copolymer. The polymer film may be an extruded product of the resin composition, for example. The protective layers may be identical to or different from each other.

The thickness of each of the protective layers is preferably from 20 μm to 100 μm. Each of the protective layers may be laminated on the polarizer through an adhesion layer (specifically an adhesive layer or a pressure-sensitive adhesive layer), or may be laminated so as to be in close contact with the polarizer (without through the adhesion layer). The adhesive layer is formed of any appropriate adhesive. The adhesive is, for example, a water-soluble adhesive using a polyvinyl alcohol-based resin as a main component. The water-soluble adhesive using the polyvinyl alcohol-based resin as a main component can preferably further contain a metal compound colloid. The metal compound colloid can be such that metal compound fine particles are dispersed in a dispersion medium, and the colloid can be a colloid that electrostatically stabilizes as a result of interactive repulsion between the charges of the same kind of the fine particles to permanently have stability. The average particle diameter of the fine particles forming the metal compound colloid can be any appropriate value as long as the average particle diameter does not adversely affect the optical characteristics of the polarizer such as a polarization characteristic. The average particle diameter is preferably from 1 nm to 100 nm, more preferably from 1 nm to 50 nm. This is because the fine particles can be uniformly dispersed in the adhesive layer, its adhesion can be secured, and a knick can be suppressed. It should be noted that the term “knick” refers to a local uneven defect that occurs at an interface between the polarizer and each of the protective layers.

C. Light-Diffusing Pressure-Sensitive Adhesive Layer

In an embodiment of the present invention, the light-diffusing pressure-sensitive adhesive layer 20 is adopted as a light diffusion layer. Such construction eliminates the need for an adhesion layer (an adhesive layer or a pressure-sensitive adhesive layer) needed when the light diffusion layer is formed of a light diffusion element. More specifically, such construction eliminates the need for an adhesion layer for laminating the polarizing plate 10 and the light diffusion layer, and an adhesion layer for laminating the reflective polarizer 30 and the light diffusion layer because the polarizing plate 10 and the reflective polarizer 30 can be laminated through the light-diffusing pressure-sensitive adhesive layer 20. As a result, the construction can contribute to the thinning of the optical member (finally a liquid crystal display apparatus), and can eliminate the adverse effects of the adhesion layer on the display characteristics of the liquid crystal display apparatus. The light-diffusing pressure-sensitive adhesive layer 20 contains a pressure-sensitive adhesive as a matrix and light-diffusible fine particles dispersed in the pressure-sensitive adhesive.

As described above, the refractive index of the pressure-sensitive adhesive is 1.47 or more, preferably from 1.47 to 1.60, more preferably from 1.47 to 1.55. Setting the refractive index of the pressure-sensitive adhesive within the range can satisfactorily suppress the glare of the light-diffusing pressure-sensitive adhesive layer in association with the increase in definition of the liquid crystal cell. The prevention of the glare becomes particularly significant in a liquid crystal display apparatus having a small pixel size and a high resolution.

Any appropriate pressure-sensitive adhesive can be used as the pressure-sensitive adhesive as long as the pressure-sensitive adhesive has the refractive index described above and provides the effects of the present invention. Specific examples thereof include a rubber-based pressure-sensitive adhesive, an acrylic pressure-sensitive adhesive, a silicone-based pressure-sensitive adhesive, an epoxy-based pressure-sensitive adhesive, and a cellulose-based pressure-sensitive adhesive. Of those, an acrylic pressure-sensitive adhesive is preferred. The use of the acrylic pressure-sensitive adhesive can provide a light-diffusing pressure-sensitive adhesive layer excellent in heat resistance and transparency. The pressure-sensitive adhesives may be used alone or in combination.

Any appropriate acrylic pressure-sensitive adhesive can be used as the acrylic pressure-sensitive adhesive as long as the pressure-sensitive adhesive has the refractive index described above and provides the effects of the present invention. The glass transition temperature of the acrylic pressure-sensitive adhesive is preferably from −60° C. to −10° C., more preferably from −55° C. to −15° C. The weight-average molecular weight of the acrylic pressure-sensitive adhesive is preferably from 200,000 to 2,000,000, more preferably from 250,000 to 1,800,000. The use of the acrylic pressure-sensitive adhesive having such characteristics can provide appropriate pressure-sensitive adhesiveness.

The acrylic pressure-sensitive adhesive is typically obtained by polymerizing a main monomer that provides pressure-sensitive adhesiveness, a comonomer that provides cohesiveness, and a functional group-containing monomer serving as a cross-linking point while providing pressure-sensitive adhesiveness. The acrylic pressure-sensitive adhesive having the above-mentioned characteristics can be synthesized by any appropriate method, and can be synthesized with reference to, for example, the “Chemistry and application of adhesion/pressure-sensitive adhesion” by Katsuhiko Nakamae published by Dainippon Tosho Publishing Co., Ltd.

Specific examples of the acrylic pressure-sensitive adhesive are described below. The acrylic pressure-sensitive adhesive includes as a base polymer a (meth)acrylic polymer (A). The (meth)acrylic polymer (A) contains as monomer units an alkyl(meth)acrylate (a1), an aromatic ring-containing (meth)acrylic monomer (a2), a carboxyl group-containing monomer (a3), and a hydroxyl group-containing monomer (a4). It should be noted that the term “(meth)acrylate” refers to an acrylate and/or a methacrylate.

An example of the alkyl(meth)acrylate (a1), which constitutes the main skeleton of the (meth)acrylic polymer (A), may be an alkyl(meth)acrylate having a linear or branched alkyl group having 1 to 18 carbon atoms. Examples of the alkyl group may include a methyl group, an ethyl group, a propyl group, an isopropyl group, a butyl group, an isobutyl group, an amyl group, a hexyl group, a cyclohexyl group, a heptyl2-ethylhexyl group, an isooctyl group, a nonyl group, a decyl group, an isodecyl group, a dodecyl group, an isomyristyl group, a lauryl group, a tridecyl group, a pentadecyl group, a hexadecyl group, a heptadecyl group, and an octadecyl group. They may be used alone or in combination. It is preferred that the average carbon number of those alkyl groups be from 3 to 9.

In the (meth)acrylic polymer, the aromatic ring-containing (meth)acrylic monomer (a2) is used as described above. A pressure-sensitive adhesive having a desired refractive index can be obtained by using a predetermined amount of a monomer having an aromatic ring structure together with the carboxyl group-containing monomer (a3) and the hydroxyl group-containing monomer (a4). For example, benzyl(meth)acrylate (a2) may be used as the aromatic ring-containing (meth)acrylic monomer (a2).

The carboxyl group-containing monomer (a3) is a compound containing in its structure a carboxyl group and containing a polymerizable unsaturated double bond such as a (meth)acryloyl group and a vinyl group. Specific examples of the carboxyl group-containing monomer (a3) include (meth)acrylic acid, carboxyethyl(meth)acrylate, carboxypentyl(meth)acrylate, itaconic acid, maleic acid, fumaric acid, and crotonic acid. Of the carboxyl group-containing monomers (a3), acrylic acid is preferred from the viewpoints of copolymerizability, price, and pressure-sensitive adhesive properties.

The hydroxyl group-containing monomer (a4) is a compound containing in its structure a hydroxyl group and containing a polymerizable unsaturated double bond such as a (meth)acryloyl group or a vinyl group. Specific examples of the hydroxyl group-containing monomer (a4) include 2-hydroxyethyl(meth)acrylate, 3-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxymethylcyclohexyl)-methyl acrylate. Of the hydroxyl group-containing monomers (a4), from the viewpoint of durability, 2-hydroxyethyl(meth)acrylate or 4-hydroxybutyl(meth)acrylate is preferred, and 4-hydroxybutyl(meth)acrylate is particularly preferred.

The (meth)acrylic polymer (A) contains as monomer units predetermined amounts of the above-mentioned monomers in terms of weight ratio with respect to all the constituent monomers (100 wt %). The weight ratio of the alkyl(meth)acrylate (a1) may be set as the balance of monomers other than the alkyl(meth)acrylate (a1), and is specifically from 67 wt % to 96.99 wt %, preferably from 71 wt % to 89.99 wt %, more preferably from 77.5 wt % to 85.97 wt %. The weight ratio of the aromatic ring-containing (meth)acrylic monomer is preferably from 1 wt % to 20 wt %, more preferably from 7 wt % to 18 wt %, still more preferably from 10 wt % to 16 wt %. The weight ratio of the carboxyl group-containing monomer (a3) is preferably from 2 wt % to 10 wt %, more preferably from 3 wt % to 10 wt %, still more preferably from 4 wt % to 6 wt %. The weight ratio of the hydroxyl group-containing monomer (a4) is preferably from 0.01 wt % to 3 wt %, more preferably from 0.01 wt % to 1 wt %, still more preferably from 0.03 wt % to 0.5 wt %. When the weight ratio of the hydroxyl group-containing monomer (a4) is less than 0.01 wt %, the durability may be insufficient in some cases.

When a pressure-sensitive adhesive composition contains a cross-linking agent, those copolymerizable monomers each serve as a reaction point with the cross-linking agent. The carboxyl group-containing monomer (a3) and the hydroxyl group-containing monomer (a4) are preferably used for improving the cohesiveness and heat resistance of the pressure-sensitive adhesive layer to be obtained because the monomers are each rich in reactivity with the cross-linking agent. In addition, the carboxyl group-containing monomer (a3) is preferred because the monomer achieves compatibility between the durability and reworkability of the layer, and the hydroxyl group-containing monomer (a4) is preferred in terms of the reworkability.

In addition to the monomer units, one or more kinds of copolymerizable monomers each having a polymerizable functional group having an unsaturated double bond such as a (meth)acryloyl group or a vinyl group may be introduced into the (meth)acrylic polymer (A) by copolymerization for the purpose of improving its adhesion and heat resistance.

Specific examples of such copolymerizable monomers include: an acid anhydride group-containing monomer such as maleic anhydride or itaconic anhydride; a caprolactone adduct of acrylic acid; a sulfonate group-containing monomer such as allylsulfonic acid, 2-(meth)acrylamido-2-methylpropanesulfonic acid, (meth)acrylamidopropanesulfonic acid, or sulfopropyl(meth)acrylate; and a phosphate group-containing monomer such as 2-hydroxyethylacryloyl phosphate.

In addition, as monomers for property modification, there are given, for example: a (N-substituted) amide-based monomer such as (meth)acrylamide, N,N-dimethyl(meth)acrylamide, N-butyl(meth)acrylamide, N-methylol(meth)acrylamide, or N-methylolpropane(meth)acrylamide; an alkylaminoalkyl(meth)acrylate-based monomer such as aminoethyl(meth)acrylate, N,N-dimethylaminoethyl(meth)acrylate, or t-butylaminoethyl(meth)acrylate; an alkoxyalkyl(meth)acrylate-based monomer such as methoxyethyl(meth)acrylate or ethoxyethyl(meth)acrylate; a succinimide-based monomer such as N-(meth)acryloyloxymethylenesuccinimide, N-(meth)acryloyl-6-oxyhexamethylenesuccinimide, N-(meth)acryloyl-8-oxyoctamethylenesuccinimide, or N-acryloylmorpholine; a maleimide-based monomer such as N-cyclohexylmaleimide, N-isopropylmaleimide, N-laurylmaleimide, or N-phenylmaleimide; and an itaconimide-based monomer such as N-methylitaconimide, N-ethylitaconimide, N-butylitaconimide, N-octylitaconimide, N-2-ethylhexylitaconimide, N-cyclohexylitaconimide, or N-laurylitaconimide.

Further, as the monomers for property modification, there may be used, for example: a vinyl-based monomer such as vinyl acetate, vinyl propionate, or N-vinylcaprolactam; a cyanoacrylate-based monomer such as acrylonitrile or methacrylonitrile; an epoxy group-containing acrylic monomer such as glycidyl(meth)acrylate; a glycol-based acrylic ester monomer such as polyethylene glycol(meth)acrylate, polypropylene glycol(meth)acrylate, methoxyethylene glycol(meth)acrylate, or methoxypolypropylene glycol(meth)acrylate; and an acrylic acid ester-based monomer such as tetrahydrofurfuryl(meth)acrylate, a fluorinated(meth)acrylate, silicone(meth)acrylate, or 2-methoxyethyl acrylate. Further, there are given, for example, isoprene, butadiene, isobutylene, and vinyl ether.

Further, as the copolymerizable monomer except the ones described above, there is given, for example, a silane-based monomer, which contains a silicon atom. Examples of the silane-based monomer include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

In addition, as the copolymerizable monomer, there may be used, for example: a polyfunctional monomer having two or more unsaturated double bonds such as a (meth)acryloyl group or a vinyl group, e.g., an esterified product of (meth)acrylic acid and a polyhydric alcohol such as tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, or caprolactone-modified dipentaerythritol hexa(meth)acrylate; and polyester(meth)acrylate, epoxy(meth)acrylate, or urethane(meth)acrylate, which is obtained by adding as the same functional group as that of the monomer component two or more unsaturated double bonds such as a (meth)acryloyl group or a vinyl group to a skeleton of polyester, epoxy, urethane, or the like.

A polymer having a weight-average molecular weight of 1,600,000 or more is typically used as the (meth)acrylic polymer (A). A polymer having a weight-average molecular weight of from 1,700,000 to 3,000,000 is preferably used in consideration of the durability, in particular, the heat resistance. The weight-average molecular weight is more preferably from 1,800,000 to 2,800,000, still more preferably from 1,900,000 to 2,500,000. When the weight-average molecular weight is less than 1,600,000, the heat resistance may be insufficient in some cases. In addition, when the weight-average molecular weight is more than 3,000,000, the durability may be insufficient in some cases. In addition, a ratio “weight-average molecular weight (Mw)/number-average molecular weight (Mn)” showing a molecular weight distribution is 1.8 or more and 10 or less, preferably from 2 to 7, more preferably from 2 to 5. When the molecular weight distribution (Mw/Mn) exceeds 10, the durability may be insufficient in some cases. It should be noted that the weight-average molecular weight and the molecular weight distribution (Mw/Mn) are determined from values measured by gel permeation chromatography (GPC) and calculated in terms of polystyrene.

The content of the pressure-sensitive adhesive in the light-diffusing pressure-sensitive adhesive layer is preferably from 50 wt % to 99.7 wt %, more preferably from 52 wt % to 97 wt %.

As described above, the volume-average particle diameter of the light-diffusible fine particles is from 1 μm to 4 μm, preferably from 2 μm to 4 μm, more preferably about 3 μm. Setting the volume-average particle diameter of the light-diffusible fine particles within the range can satisfactorily suppress the glare of the light-diffusing pressure-sensitive adhesive layer in association with the increase in definition of the liquid crystal cell. The prevention of the glare becomes particularly significant in a liquid crystal display apparatus having a small pixel size and a high resolution. The volume-average particle diameter can be measured with, for example, an ultracentrifugal automatic particle size distribution-measuring apparatus.

Any appropriate light-diffusible fine particles can be used as the light-diffusible fine particles as long as the particles have the volume-average particle diameter described above and provide the effects of the present invention. Specific examples thereof include inorganic fine particles and polymer fine particles. The light-diffusible fine particles are preferably the polymer fine particles. A material for the polymer fine particles is, for example, a silicone resin, a methacrylic resin (such as polymethyl methacrylate), a polystyrene resin, a polyurethane resin, or a melamine resin. Those resins can each provide a light-diffusing pressure-sensitive adhesive layer excellent in diffusion performance because the resins each have excellent dispersibility in the pressure-sensitive adhesive and an appropriate refractive index difference from the pressure-sensitive adhesive. Of those, a silicone resin or polymethyl methacrylate is preferred. The shape of each of the light-diffusible fine particles can be, for example, a true spherical shape, a flat shape, or an amorphous shape. The light-diffusible fine particles may be used alone or in combination.

The refractive index of each of the light-diffusible fine particles is preferably from 1.30 to 1.70, more preferably from 1.40 to 1.65.

The absolute value of a refractive index difference between each of the light-diffusible fine particles and the pressure-sensitive adhesive is preferably more than 0 and 0.2 or less, more preferably more than 0 and 0.15 or less, still more preferably from 0.01 to 0.13.

The content of the light-diffusible fine particles in the light-diffusing pressure-sensitive adhesive layer is preferably from 0.3 wt % to 50 wt %, more preferably from 3 wt % to 48 wt %. Setting the compounding amount of the light-diffusible fine particles within the range can provide a light-diffusing pressure-sensitive adhesive layer having excellent light diffusion performance.

The light-diffusing pressure-sensitive adhesive layer may contain any appropriate additive. Examples of the additive include an antistatic agent and an antioxidant.

The light diffusion performance of the light-diffusing pressure-sensitive adhesive layer can be represented by, for example, a haze value and/or a light diffusion half-value angle. The haze value of the light-diffusing pressure-sensitive adhesive layer is preferably from 80% to 95%, more preferably from 85% to 95%, still more preferably from 88% to 92%. Setting the haze value within the range provides desired diffusion performance and hence can satisfactorily suppress the occurrence of moire and glare. The light diffusion half-value angle of the light-diffusing pressure-sensitive adhesive layer is preferably from 5° to 50°, more preferably from 10° to 30°. The light diffusion performance of the light-diffusing pressure-sensitive adhesive layer can be controlled by adjusting, for example, a constituent material for the matrix (pressure-sensitive adhesive), and a constituent material for, and the volume-average particle diameter and compounding amount of, the light-diffusible fine particles.

The total light transmittance of the light-diffusing pressure-sensitive adhesive layer is preferably 75% or more, more preferably 80% or more, still more preferably 85% or more.

The thickness of the light-diffusing pressure-sensitive adhesive layer can be appropriately adjusted depending on, for example, its construction and diffusion performance. For example, the thickness is preferably from 5 μm to 100 μm.

D. Reflective Polarizer

The reflective polarizer 30 has a function of transmitting polarized light in a specific polarized state (polarization direction) and reflecting light in a polarized state other than the foregoing. The reflective polarizer 30 may be of a linearly polarized light separation type or may be of a circularly polarized light separation type. Hereinafter, description is given by taking the reflective polarizer of the linearly polarized light separation type as an example. It should be noted that the reflective polarizer of the circularly polarized light separation type is, for example, a laminate of a film obtained by fixing a cholesteric liquid crystal and a λ/4 plate.

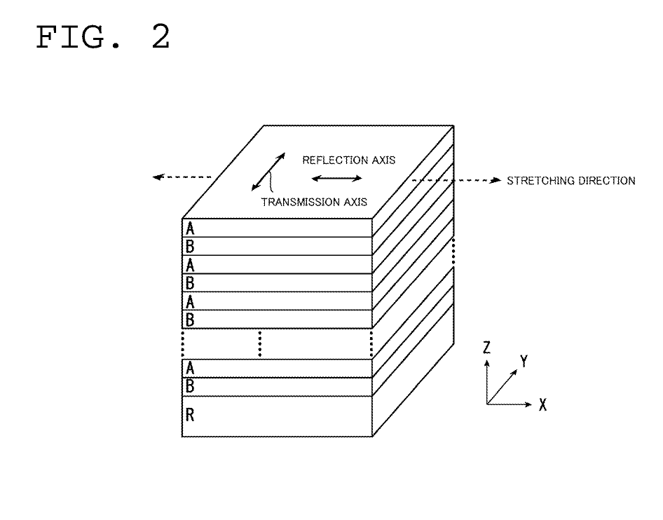

FIG. 2 is a schematic perspective view of an example of a reflective polarizer. The reflective polarizer is a multilayer laminate obtained by alternately laminating a layer A having birefringence and a layer B substantially free of birefringence. For example, the total number of the layers of such multilayer laminate can be from 50 to 1,000. In the illustrated example, a refractive index nx in the x-axis direction of the A layer is larger than a refractive index ny in the y-axis direction thereof, and a refractive index nx in the x-axis direction of the B layer and a refractive index ny in the y-axis direction thereof are substantially equal to each other. Therefore, a refractive index difference between the A layer and the B layer is large in the x-axis direction, and is substantially zero in the y-axis direction. As a result, the x-axis direction serves as a reflection axis and the y-axis direction serves as a transmission axis. The refractive index difference between the A layer and the B layer in the x-axis direction is preferably from 0.2 to 0.3. It should be noted that the x-axis direction corresponds to the stretching direction of the reflective polarizer in a production method to be described later.

The A layer is preferably formed of a material that expresses birefringence when stretched. Typical examples of such material include naphthalene dicarboxylic acid polyester (such as polyethylene naphthalate), polycarbonate, and an acrylic resin (such as polymethyl methacrylate). Of those, the polyethylene naphthalate is preferred. The B layer is preferably formed of a material that is substantially free of expressing birefringence even when stretched. Such material is typically, for example, the copolyester of naphthalene dicarboxylic acid and terephthalic acid.

The reflective polarizer transmits light having a first polarization direction (such as a p-wave) and reflects light having a second polarization direction perpendicular to the first polarization direction (such as an s-wave) at an interface between the A layer and the B layer. Part of the reflected light passes as light having the first polarization direction through the interface between the A layer and the B layer, and the other part thereof is reflected as light having the second polarization direction at the interface. Such reflection and transmission are repeated many times in the reflective polarizer, and hence the utilization efficiency of light can be improved.

In one embodiment, the reflective polarizer may include a reflective layer R as the outermost layer on a side opposite to the polarizing plate 10 as illustrated in FIG. 2. Light that has finally returned to the outermost portion of the reflective polarizer without being utilized can be additionally utilized by providing the reflective layer R, and hence the utilization efficiency of the light can be additionally improved. The reflective layer R typically expresses a reflecting function by virtue of the multilayer structure of a polyester resin layer.

The total thickness of the reflective polarizer can be appropriately set depending on, for example, purposes and the total number of the layers in the reflective polarizer. The total thickness of the reflective polarizer is preferably from 10 μm to 150 μm. When the total thickness falls within such range, a distance between the light-diffusing pressure-sensitive adhesive layer and the prism portion of the prism sheet can be caused to fall within a desired range. As a result, a liquid crystal display apparatus that suppresses the occurrence of the moire and has high brightness can be realized.

In one embodiment, in the optical member 100, the reflective polarizer 30 is arranged so as to transmit light having a polarization direction parallel to the transmission axis of the polarizing plate 10. That is, the reflective polarizer 30 is arranged so that its transmission axis may be in a direction approximately parallel to the direction of the transmission axis of the polarizing plate 10. With such construction, light to be absorbed by the polarizing plate 10 can be recycled, the utilization efficiency can be additionally improved, and the brightness can be improved.

The reflective polarizer can be typically produced by combining co-extrusion and lateral stretching. The co-extrusion can be performed by any appropriate system. For example, the system may be a feed block system or may be a multi-manifold system. For example, a material constituting the A layer and a material constituting the B layer are extruded in a feed block, and are then formed into a plurality of layers with a multiplier. It should be noted that such apparatus for forming the materials into a plurality of layers is known to one skilled in the art. Next, the resultant long multilayer laminate is typically stretched in a direction (TD) perpendicular to its conveying direction. The material constituting the A layer (such as polyethylene naphthalate) is increased in refractive index only in the stretching direction by the lateral stretching, and as a result, expresses birefringence. The material constituting the B layer (such as the copolyester of naphthalene dicarboxylic acid and terephthalic acid) is not increased in refractive index in any direction even by the lateral stretching. As a result, a reflective polarizer having a reflection axis in the stretching direction (TD) and having a transmission axis in the conveying direction (MD) can be obtained (the TD corresponds to the x-axis direction of FIG. 2 and the MD corresponds to the y-axis direction thereof). It should be noted that a stretching operation can be performed with any appropriate apparatus.

A polarizer described in, for example, JP 9-507308 A may be used as the reflective polarizer.

A commercial product may be used as it is as the reflective polarizer, or the commercial product may be subjected to secondary processing (such as stretching) before use. The commercial product is, for example, a product available under the trade name “DBEF” from 3M Company or a product available under the trade name “APF” from 3M Company.

The reflective polarizer 30 is attached to the polarizing plate 10 through the light-diffusing pressure-sensitive adhesive layer 20.

E. Prism Sheet

The prism sheet 40 is arranged on the side of the reflective polarizer 30 opposite to the light-diffusing pressure-sensitive adhesive layer 20. The prism sheet 40 typically includes the base portion 41 and the prism portion 42. The distance between the light-diffusing pressure-sensitive adhesive layer 20 and the prism portion 42 can be controlled by adjusting the thickness of the base portion 41. It should be noted that in this embodiment, the base portion 41 is not necessarily needed to be provided because the reflective polarizer 30 can function as a base portion for supporting the prism portion 42. In this case, the distance between the light-diffusing pressure-sensitive adhesive layer 20 and the prism portion 42 can be controlled by adjusting the thickness of the reflective polarizer 30. When the optical member of the present invention is arranged on the backlight side of a liquid crystal display apparatus, the prism sheet 40 guides polarized light, which has been emitted from the light guide plate of the backlight unit of the apparatus, as polarized light having the maximum intensity in an approximately normal direction of the liquid crystal display apparatus to the polarizing plate 10 through the reflective polarizer 30 and the light-diffusing pressure-sensitive adhesive layer 20 by means of, for example, total reflection in the prism portion 42 while maintaining the polarized state of the light. It should be noted that the term “approximately normal direction” comprehends a direction at a predetermined angle with respect to a normal direction, e.g., a direction at an angle in the range of ±10° with respect to the normal direction.

The prism sheet 40 is attached to the reflective polarizer 30 through any appropriate adhesion layer (such as an adhesive layer or a pressure-sensitive adhesive layer: not shown).

E-1. Prism Portion

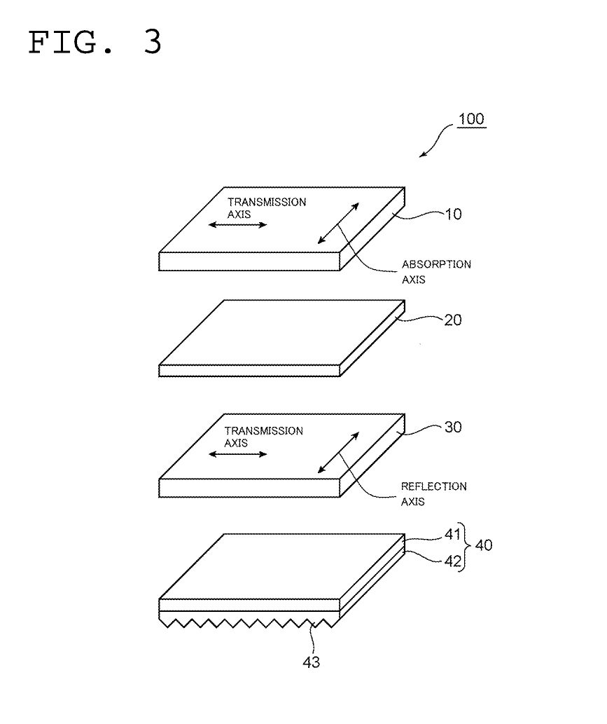

In one embodiment, as illustrated in each of FIGS. 1 and 3, the prism sheet 40 (substantially the prism portion 42) includes an array of a plurality of unit prisms 43, which are convex toward a side opposite to the reflective polarizer 30, in a parallel manner. Each of the unit prisms 43 is preferably columnar, and its lengthwise direction (ridge line direction) is directed toward a direction approximately perpendicular to the transmission axis of the polarizing plate 10 and the transmission axis of the reflective polarizer 30. Note that, in this specification, the expressions “substantially perpendicular” and “approximately perpendicular” include a case where an angle formed by two directions is 90°±10°, preferably 90°±7°, more preferably 90 °±5°. The expressions “substantially parallel” and “approximately parallel” include a case where an angle formed by two directions is 0°±10°, preferably 0°±7°, more preferably 0 °±5°. Moreover, in this specification, such a simple expression “perpendicular” or “parallel” can include a substantially perpendicular state or a substantially parallel state. It should be noted that the prism sheet 40 may be arranged so that the ridge line direction of each of the unit prisms 43, and each of the transmission axis of the polarizing plate 10 and the transmission axis of the reflective polarizer 30 may form a predetermined angle (the so-called oblique placement). The adoption of such construction can prevent the occurrence of the moire in an additionally satisfactory manner in some cases. The range of the oblique placement is preferably 20° or less, more preferably 15° or less.

Any appropriate construction can be adopted as the shape of each of the unit prisms 43 as long as the effects of the present invention are obtained. The shape of a section of each of the unit prisms 43 parallel to its arrangement direction and parallel to its thickness direction may be a triangular shape or may be any other shape (e.g., such a shape that one of, or each of both, the inclined planes of a triangle has a plurality of flat surfaces having different tilt angles). The triangular shape may be a shape asymmetric with respect to a straight line passing the apex of the unit prism and perpendicular to the surface of the sheet (e.g., a scalene triangle), or may be a shape symmetric with respect to the straight line (e.g., an isosceles triangle). Further, the apex of the unit prism may be of a chamfered curved surface shape, or may be of a shape whose section is a trapezoid, the shape being obtained by such cutting that its tip becomes a flat surface. Detailed shapes of the unit prisms 43 can be appropriately set depending on purposes. For example, a construction described in JP 11-84111 A can be adopted for each of the unit prisms 43.

The distance between the prism portion 42 and the light-diffusing pressure-sensitive adhesive layer 20 is preferably from 75 μm to 250 μm. Securing such distance between the prism portion and the light-diffusing pressure-sensitive adhesive layer can satisfactorily suppress the occurrence of the moire while maintaining the front contrast and brightness of the liquid crystal display apparatus. The distance between the prism portion 42 and the light-diffusing pressure-sensitive adhesive layer 20 can be controlled by adjusting, for example, the thickness of the reflective polarizer 30, the base portion 41, and/or the adhesion layer between the reflective polarizer 30 and the prism sheet 40. It should be noted that the distance between the prism portion 42 and the light-diffusing pressure-sensitive adhesive layer 20 refers to a distance between the flat surface of the prism portion 42 (surface opposite to the apices of the unit prisms 43) and a surface on the side of the light-diffusing pressure-sensitive adhesive layer 20 closer to the reflective polarizer 30.

E-2. Base Portion

When the prism sheet 40 is provided with the base portion 41, the base portion 41 and the prism portion 42 may be integrally formed by, for example, subjecting a single material to extrusion, or the prism portion may be shaped on a film for the base portion. The thickness of the base portion is preferably from 25 μm to 150 μm. With such thickness, the distance between the light-diffusing pressure-sensitive adhesive layer and the prism portion can be caused to fall within the desired range. Further, such thickness is preferred from the viewpoints of the handling property and strength of the prism sheet.

Any appropriate material can be adopted as a material constituting the base portion 41 depending on purposes and the construction of the prism sheet. When the prism portion is shaped on the film for the base portion, the film for the base portion is specifically, for example, a film formed of cellulose triacetate (TAC), a (meth)acrylic resin such as polymethyl methacrylate (PMMA), or a polycarbonate (PC) resin. The film is preferably an unstretched film.

When the base portion 41 and the prism portion 42 are integrally formed of a single material, the same material as a material for forming the prism portion when the prism portion is shaped on the film for the base portion can be used as the material. Examples of the material for forming the prism portion include epoxy acrylate- and urethane acrylate-based reactive resins (such as an ionizing radiation-curable resin). When the prism sheet of an integral construction is formed, a polyester resin such as PC or PET, an acrylic resin such as PMMA or MS, or an optically transparent thermoplastic resin such as cyclic polyolefin can be used.

It is preferred that the base portion 41 substantially have optical isotropy. The phrase “substantially have optical isotropy” as used herein means that a retardation value is so small as to have substantially no influences on the optical characteristics of the liquid crystal display apparatus. For example, an in-plane retardation Re of the base portion is preferably 20 nm or less, more preferably 10 nm or less. It should be noted that the in-plane retardation Re is an in-plane retardation value measured at 23° C. with light having a wavelength of 590 nm. The in-plane retardation Re is represented by the equation “Re=(nx−ny)×d.” Here, nx represents a refractive index in the direction in which a refractive index becomes maximum in the plane of the optical member (i.e., a slow axis direction), ny represents a refractive index in a direction perpendicular to the slow axis in the plane (i.e., a fast axis direction), and d represents the thickness (nm) of the optical member.

Further, the photoelastic coefficient of the base portion 41 is preferably from −10×10⁻¹² m²/N to 10×10⁻¹² m²/N, more preferably from −5×10⁻¹² m²/N to 5×10⁻¹² m²/N, still more preferably from −3×10⁻¹² m²/N to 3×10⁻¹² m²/N.

F. Retardation Layer

The optical member 100 may further have any appropriate retardation layer at any appropriate position depending on purposes (not shown). The positions at which retardation layers are arranged, the number of the layers, the birefringence (refractive index ellipsoid) of each of the layers, and the like can be appropriately selected depending on, for example, the drive mode of a liquid crystal cell and desired characteristics. The retardation layer may also serve as a protective layer for a polarizer depending on purposes. Hereinafter, a typical example of the retardation layer applicable to the optical member of the present invention is described.

For example, in the case where the optical member is used in a liquid crystal display apparatus of an IPS mode, the optical member may have a first retardation layer, which satisfies a relationship of nx₁>ny₁>nz₁, on the side of the polarizing plate 10 opposite to the light-diffusing pressure-sensitive adhesive layer 20. In this case, the optical member may further have a second retardation layer, which satisfies a relationship of nz₂>nx₂>ny₂, outside the first retardation layer (on a side opposite to the polarizing plate 10). The second retardation layer may be the so-called positive C-plate that satisfies a relationship of nz₂>nx₂=ny₂. The slow axis of the first retardation layer and the slow axis of the second retardation layer may be perpendicular or parallel to each other. The axes are preferably parallel to each other in consideration of the viewing angle and productivity of the optical member.

An in-plane retardation Re₁ of the first retardation layer is preferably from 60 nm to 140 nm. An Nz coefficient Nz₁ of the first retardation layer is preferably from 1.1 to 1.7. An in-plane retardation Re₂ of the second retardation layer is preferably from 10 nm to 70 nm. A thickness direction retardation Rth₂ of the second retardation layer is preferably from −120 nm to −40 nm. The in-plane retardations Re are as defined in the foregoing. The thickness direction retardation Rth is represented by the equation “Rth={(nx+ny)/2−nz}×d.” The Nz coefficient is represented by the equation “Nz=(nx−nz)/(nx−ny).” Here, nx and ny are as defined in the foregoing. nz represents a refractive index in the thickness direction of the optical member (here, the first retardation layer or the second retardation layer). It should be noted that the suffixes “1” and “2” represent the first retardation layer and the second retardation layer, respectively.

Alternatively, the first retardation layer may be a retardation layer that satisfies a relationship of nx₁>nz₁>ny₁. In this case, the second retardation layer is preferably the so-called negative C-plate that satisfies a relationship of nx₂=ny₂>nz₂. It should be noted that for example, the expression “nx=ny” as used herein comprehends not only the case where nx and ny are strictly equal to each other but also the case where nx and ny are substantially equal to each other. The purport of the phrase “substantially equal” as used herein is that the following case is also comprehended: the case where nx and ny are different from each other to the extent that the difference has no influences on the entire optical characteristics of the liquid crystal display apparatus in practical use. Therefore, the negative C-plate in this embodiment comprehends the case where the plate has biaxiality.

In addition, for example, in the case where the optical member is used in a liquid crystal display apparatus of a VA mode, the optical member may be used as a circularly polarizing plate. Specifically, the optical member may have the first retardation layer that functions as a λ/4 plate on the side of the polarizing plate 10 opposite to the light-diffusing pressure-sensitive adhesive layer 20. In this case, an angle formed between the absorption axis of the polarizer and the slow axis of the first retardation layer is preferably substantially 45° or substantially 135°. Further, in this case, the liquid crystal display apparatus preferably includes a retardation layer that functions as a λ/4 plate between its liquid crystal cell and viewer side polarizing plate. The optical member may further have the second retardation layer, which satisfies a relationship of nz₂>nx₂>ny₂, between the polarizer and the first retardation layer. Further, when the retardation wavelength dispersion value (Re_{cell}[450]/Re_{cell}[550]) of the liquid crystal cell is represented by α_{cell} and the retardation wavelength dispersion value (Re₁[450]/Re₁[550]) of the first retardation layer is represented by α₁, the ratio α₁/α_{cell} is preferably from 0.95 to 1.02. In addition, the Nz coefficient of the first retardation layer preferably satisfies a relationship of 1.1<Nz₁≦2.4, and the Nz coefficient of the second retardation layer preferably satisfies a relationship of −2≦Nz₂≦−0.1.

In addition, for example, when the optical member is used in the liquid crystal display apparatus of the VA mode, the optical member may be used as a linearly polarizing plate. Specifically, the optical member may have the first retardation layer, which satisfies a relationship of nx₁>ny₁>nz₁, on the side of the polarizing plate 10 opposite to the light-diffusing pressure-sensitive adhesive layer 20. The in-plane retardation Re₁ of the first retardation layer is preferably from 20 nm to 200 nm, more preferably from 30 nm to 150 nm, still more preferably from 40 nm to 100 nm. A thickness direction retardation Rth₁ of the first retardation layer is preferably from 100 nm to 800 nm, more preferably from 100 nm to 500 nm, still more preferably from 150 nm to 300 nm. The Nz coefficient of the first retardation layer is preferably from 1.3 to 8.0.

G. Polarizing Plate Set

The optical member of the present invention can be typically used as a polarizing plate arranged on the side of a liquid crystal display apparatus opposite to its viewer side (hereinafter sometimes referred to as “back surface side polarizing plate”). In this case, a polarizing plate set including the back surface side polarizing plate and a viewer side polarizing plate can be provided. Any appropriate polarizing plate can be adopted as the viewer side polarizing plate. The viewer side polarizing plate typically includes a polarizer (such as an absorption-type polarizer) and a protective layer arranged on at least one side of the polarizer. Those described in the section B can be used as the polarizer and the protective layer. The viewer side polarizing plate may further have any appropriate optical functional layer (such as a retardation layer, a hard coat layer, an antiglare layer, or an antireflection layer) depending on purposes. The polarizing plate set is arranged on each side of a liquid crystal cell so that the absorption axis of (the polarizer of) the viewer side polarizing plate and the absorption axis of (the polarizer of) the back surface side polarizing plate may be substantially perpendicular or parallel to each other.

H. Liquid Crystal Display Apparatus

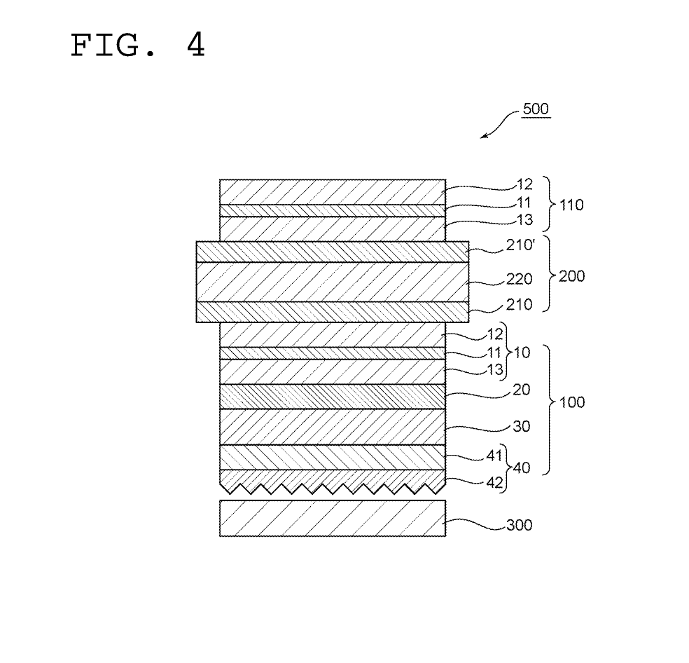

FIG. 4 is a schematic sectional view of a liquid crystal display apparatus according to one embodiment of the present invention. A liquid crystal display apparatus 500 includes a liquid crystal cell 200, a viewer side polarizing plate 110 arranged on the viewer side of the liquid crystal cell 200, the optical member 100 of the present invention as a back surface side polarizing plate arranged on the side of the liquid crystal cell 200 opposite to the viewer side, and a backlight unit 300 arranged on the side of the optical member 100 opposite to the liquid crystal cell 200. The optical member 100 is as described in the sections A to F. The viewer side polarizing plate is as described in the section G. In the illustrated example, the viewer side polarizing plate 110 includes the polarizer 11, the protective layer 12 arranged on one side of the polarizer, and the protective layer 13 arranged on the other side of the polarizer 11. The viewer side polarizing plate 110 and the optical member (back surface side polarizing plate) 100 are arranged so that their respective absorption axes may be substantially perpendicular or parallel to each other. Any appropriate construction can be adopted for the backlight unit 300. For example, the backlight unit 300 may be of an edge light system or may be of a direct system. When the direct system is adopted, the backlight unit 300 includes, for example, a light source, a reflective film, and a diffuser (none of which is shown). When the edge light system is adopted, the backlight unit 300 can further include a light guide plate and a light reflector (none of which is shown).

The liquid crystal cell 200 includes a pair of substrates 210 and 210′ and a liquid crystal layer 220 as a display medium sandwiched between the substrates. Ina general configuration, on the substrate 210′ as one in the pair, a color filter and a black matrix are provided, and on the substrate 210 as the other in pair, there are provided switching elements for controlling electro-optical property of the liquid crystal, scanning lines for giving gate signals to the switching elements and signal lines for giving source signals thereto, and pixel electrodes and counter electrodes. An interval (cell gap) between the above-mentioned substrates 210 and 210′ can be controlled by spacers and the like. On sides of the above-mentioned substrates 210 and 210′, which are brought into contact with the liquid crystal layer 220, for example, alignment films made of polyimide or the like can be provided.

In one embodiment, the liquid crystal layer 220 includes liquid crystal molecules aligned in a homogeneous alignment in a state where an electric field is not present. The liquid crystal layer (liquid crystal cell as a result) as described above typically exhibits a three-dimensional refractive index of nx>ny=nz. Note that, in this specification, ny=nz includes not only a case where ny and nz are completely the same, but also a case where ny and nz are substantially the same.

As a typical example of a drive mode using the liquid crystal layer that exhibits the three-dimensional refractive index as described above, the in-plane switching (IPS) mode, the fringe field switching (FFS) mode, and the like are given. In the above-mentioned IPS mode, by using the electrically controlled birefringence (ECB) effect, the liquid crystal molecules aligned in the homogeneous alignment in the state where an electric field is not present are allowed to respond, for example, to an electric field (also referred to as a horizontal electric field), which is generated by the counter electrode and pixel electrode, each being formed of metal, and is parallel to the substrates. More specifically, for example, as described in “Monthly Display, July” pp. 83 to 88 (1997), published by Techno Times Co., Ltd. and “Ekisho vol. 2, No. 4” pp. 303 to 316 (1998), published by The Japanese Liquid Crystal Society, when an alignment direction of the liquid crystal cell at the time when no electric field is applied thereto and an absorption axis of a polarizer on one side are allowed to coincide with each other, and the upper and lower polarizing plates are arranged perpendicularly to each other, the normally black mode provides completely black display in the state where no electric field is present. When the electric field is present, the liquid crystal molecules perform a rotation operation while remaining parallel to the substrates so that a transmittance corresponding to a rotation angle can be obtained. Note that, the above-mentioned IPS mode includes the super in-plane switching (S-IPS) mode and the advanced super in-plane switching (AS-IPS) mode, each of which employs a V-shaped electrode, a zigzag electrode, or the like.

In the above-mentioned FFS mode, by using the electrically controlled birefringence effect, the liquid crystal molecules aligned in the homogeneous alignment in the state where no electric field is present are allowed to respond, for example, to an electric field (also referred to as a horizontal electric field), which is generated by the counter electrode and pixel electrode, each being formed of a transparent conductor, and is parallel to the substrates. Note that, the horizontal electric field in the FFS mode is also referred to as a fringe electric field. This fringe electric field can be generated by setting an interval between the counter electrode and the pixel electrode, each of which is formed of the transparent conductor, narrower than the cell gap. More specifically, for example, as described in “SID (Society for Information Display) 2001 Digest, pp. 484 to 487” and JP 2002-031812 A, when an alignment direction of the liquid crystal cell at the time when no electric field is applied thereto and an absorption axis of a polarizer on one side are allowed to coincide with each other, and the upper and lower polarizing plates are arranged perpendicularly to each other, the normally black mode provides completely black display in the state where no electric field is present. When the electric field is present, the liquid crystal molecules perform a rotation operation while remaining parallel to the substrates so that a transmittance corresponding to a rotation angle can be obtained. Note that, the above-mentioned FFS mode includes the advanced fringe field switching (A-FFS) mode and the ultra fringe field switching (U-FFS) mode, each of which employs a V-shaped electrode, a zigzag electrode, or the like.

In the drive mode (for example, the IPS mode, the FFS mode) using the liquid crystal molecules aligned in the homogeneous alignment in the state where no electric field is present, there is no oblique gray-scale inversion, and an oblique viewing angle thereof is wide, and accordingly, there is an advantage in that visibility in an oblique direction is excellent even when the surface light source directed in the front direction, which is used in the present invention, is used.

In another embodiment, the liquid crystal layer 220 includes liquid crystal molecules aligned in a homeotropic alignment in the state where no electric field is present. The liquid crystal layer (liquid crystal cell as a result) as described above typically exhibits a three-dimensional refractive index of nz>nx=ny. As a drive mode using the liquid crystal molecules aligned in the homeotropic alignment in the state where no electric field is present, for example, the vertical alignment (VA) mode is given. The VA mode includes the multi-domain VA (MVA) mode.

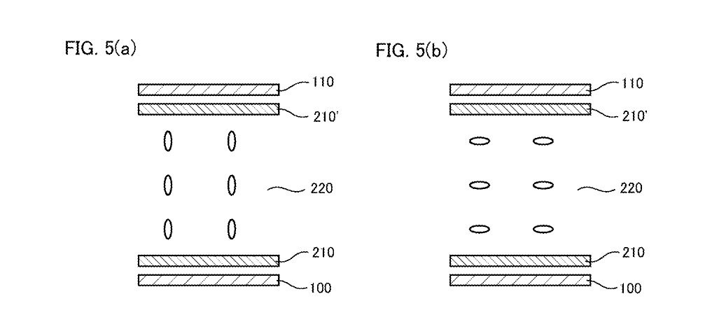

FIGS. 5(a) and 5(a) are schematic sectional views illustrating aligned states of the liquid crystal molecules in the VA mode. As illustrated in FIG. 5(a), the liquid crystal molecules in the VA mode are aligned, at the time when no voltage is applied thereto, approximately vertically (normal direction) on the substrates 210 and 210′. Here, the term “approximately vertical” also includes a case where an alignment vector of the liquid crystal molecules is inclined with respect to the normal direction, that is, a case where the liquid crystal molecules have a tilt angle. The tilt angle (angle from the normal line) is preferably 10° or less, more preferably 5° or less, particularly preferably 1° or less. The liquid crystal molecules have the tilt angle in such a range so that the liquid crystal display apparatus can be excellent in contrast. Moreover, moving picture display characteristics can be enhanced. The approximately vertical alignment as described above can be realized, for example, by arranging nematic liquid crystal, which has negative dielectric anisotropy, between substrates on which vertical alignment films are formed. In such a state, light of linearly polarized light, which passes through the optical member 100 and enters the liquid crystal layer 220, travels along a direction of a major axis of the liquid crystal molecules aligned approximately vertically. The birefringence is not generated substantially in a major axis direction of the liquid crystal molecules, and accordingly, the incident light travels without changing a polarization direction thereof, and is absorbed by the viewer side polarizing plate 110 having a transmission axis perpendicular to the optical member 100. In this manner, display of a dark state is obtained at the time when no voltage is applied (normally black mode). As illustrated in FIG. 5(b), when a voltage is applied between the electrodes, the major axis of the liquid crystal molecules is aligned parallel to the substrate surfaces. The liquid crystal molecules in this state exhibit the birefringence to the light of the linearly polarized light, which passes through the optical member 100 and enters the liquid crystal layer, and the polarization state of the incident light is changed in response to an inclination of the liquid crystal molecules. The light that passes through the liquid crystal layer 220 at a time when a predetermined maximum voltage is applied becomes, for example, linearly polarized light in which a polarization direction is rotated by 90°, and accordingly, the light transmits through the viewer side polarizing plate 110, and display of a bright state is obtained. When the state where no voltage is applied is set again, the display can be returned to the display of the dark state by alignment regulating force. Moreover, the inclination of the liquid crystal molecules is controlled by changing the applied voltage, and transmission intensity of the light from the viewer side polarizing plate 110 is changed so that gray-scale display becomes possible.

In the liquid crystal display apparatus 500, a distance between opposing black matrices in one pixel of the liquid crystal cell (i.e., each of the R, G, and B pixels) is preferably 200 μm or less, more preferably 150 μm or less, still more preferably 120 μm or less. In a liquid crystal cell that has been currently put into practical use, a lower limit for the distance is, for example, 25 μm. The use of the optical member and/or polarizing plate set described in the sections A to G in a liquid crystal display apparatus having a liquid crystal cell of such pixel size makes a glare-preventing effect significant. It should be noted that when the pixel is a rectangle, the distance between the opposing black matrices refers to a distance between the opposing black matrices in its short side direction.

### Examples

The present invention is specifically described below by way of Examples, but the present invention is not limited to Examples. Testing and evaluating methods in Examples are as described below. Moreover, unless particularly specified, “parts” and “%” in Examples are weight-based units.

### (1) Refractive Index of Pressure-Sensitive Adhesive

The refractive index of a pressure-sensitive adhesive applied onto a transparent base material and free of light-diffusible fine particles was measured with an Abbe refractometer (DR-M2 manufactured by ATAGO CO., LTD.).

### (2) Haze Value

A light diffusion layer used in each of Examples and Comparative Examples was measured for its haze value by a method specified in JIS 7136 with a haze meter (manufactured by MURAKAMI COLOR RESEARCH LABORATORY, trade name “HN-150”).

### (3) Moire

A liquid crystal display apparatus obtained in each of Examples and Comparative Examples was caused to display a white color on its entire screen, and the extent to which moire occurred was visually observed. The case where no moire could be observed even when the display apparatus was visually observed from a position distant from the apparatus by 100 mm for 1 minute while an observation angle was changed was represented by Symbol “⊚” (which means “excellent”), the case where no moire could be observed even when the display apparatus was visually observed from a position distant from the apparatus by 500 mm for 1 minute while the observation angle was changed was represented by Symbol “∘” (which means “good”), and the case where the moire was able to be observed even when the display apparatus was observed from a position distant from the apparatus by 500 mm or more was represented by Symbol “x” (which means “insufficient”).

### (4) Glare

The liquid crystal display apparatus obtained in each of Examples and Comparative Examples was caused to display a white color on its entire screen, and the extent to which glare occurred was visually observed. The case where no glare was observed was represented by Symbol “⊚”, the case where the glare was slightly observed was represented by Symbol “∘”, and the case where the glare was clearly observed was represented by Symbol “x”.

### (5) Front Brightness of Liquid Crystal Display Apparatus

The liquid crystal display apparatus obtained in each of Examples and Comparative Examples was caused to display a white color on its entire screen and measured for its front brightness with a conoscope manufactured by AUTRONIC MELCHERS. The case where the front brightness was 500 cd/m² or more was represented by Symbol “⊚”, the case where the front brightness was 200 cd/m² or more was represented by Symbol “∘”, and the case where the front brightness was less than 200 cd/m² was represented by Symbol “x”.

### Example 1

### Production of Film for First Retardation Layer

A commercially available polymer film [manufactured by Optes Inc., trade name: “ZeonorFilm ZF14-130 (thickness: 60 μm, glass transition temperature: 136° C.)”] whose main component was a cyclic polyolefin-based polymer was subjected to fixed-end uniaxial stretching in its width direction with a tenter stretching machine at a temperature of 158° C. in such a manner that its film width was 3.0 times as large as the original film width (lateral stretching step). The resultant film was a negative biaxial plate (three-dimensional refractive index: nx>ny>nz) having a fast axis in the conveying direction. The negative biaxial plate had an in-plane retardation of 118 nm and an Nz coefficient of 1.16.

(Production of Film for Second Retardation Layer)

A pellet-shaped resin of a styrene-maleic anhydride copolymer (manufactured by Nova Chemicals Japan Ltd., product name: “DYLARK D232”) was extruded with a single screw extruder and a T die at 270° C., and the resultant sheet-shaped molten resin was cooled with a cooling drum to obtain a film having a thickness of 100 μm. The film was subjected to free-end uniaxial stretching in the conveying direction with a roll stretching machine at a temperature of 130° C. and a stretching ratio of 1.5 times to obtain a retardation film having a fast axis in the conveying direction (longitudinal stretching step). The resultant film was subjected to fixed-end uniaxial stretching in its width direction with a tenter stretching machine at a temperature of 135° C. in such a manner that its film width was 1.2 times as large as the film width after the longitudinal stretching, thereby obtaining a biaxially stretched film having a thickness of 50 μm (lateral stretching step). The resultant film was a positive biaxial plate (three-dimensional refractive index: nz>nx>ny) having a fast axis in the conveying direction. The positive biaxial plate had an in-plane retardation of 20 nm and a thickness direction retardation Rth of −80 nm.

(Production of Polarizing Plate with Retardation Layers)

A polymer film containing polyvinyl alcohol as a main component [manufactured by KURARAY CO., LTD., trade name “9P75R (thickness: 75 μm, average polymerization degree: 2,400, saponification degree: 99.9 mol %)”] was stretched in its conveying direction at a ratio of 1.2 times while being immersed in a water bath for 1 minute. After that, the film was stretched at a ratio of 3 times with reference to a film (original length), which had not been stretched at all, in the conveying direction while being dyed by being immersed in an aqueous solution having an iodine concentration of 0.3 wt % for 1 minute. Next, the stretched film was further stretched at a ratio of up to 6 times with reference to the original length in the conveying direction while being immersed in an aqueous solution having a boric acid concentration of 4 wt % and a potassium iodide concentration of 5 wt %. The resultant was dried at 70° C. for 2 minutes to obtain a polarizer.

Meanwhile, an alumina colloid-containing adhesive was applied to one surface of a triacetylcellulose (TAC) film (manufactured by KONICA MINOLTA, INC., product name “KC4UW,” thickness: 40 μm), and the resultant was laminated on one surface of the polarizer obtained in the foregoing by a roll-to-roll process so that the conveying directions of both the polarizer and the film were parallel to each other. It should be noted that the alumina colloid-containing adhesive was prepared by: dissolving 50 parts by weight of methylol melamine with respect to 100 parts by weight of a polyvinyl alcohol-based resin having an acetoacetyl group (average polymerization degree: 1,200, saponification degree: 98.5 mol %, acetoacetylation degree: 5 mol %) in pure water to prepare an aqueous solution having a solid content of 3.7 wt %; and adding 18 parts by weight of an aqueous solution containing an alumina colloid having a positive charge (average particle diameter: 15 nm) at a solid content of 10 wt % to 100 parts by weight of the resultant aqueous solution. Subsequently, a film for a first retardation layer having applied thereto the alumina colloid-containing adhesive was laminated on a surface of the polarizer opposite to the TAC film by the roll-to-roll process so that their conveying directions were parallel to each other. After that, the laminate was dried at 55° C. for 6 minutes. A film for a second retardation layer was laminated on the surface of the first retardation layer of the laminate after the drying through an acrylic pressure-sensitive adhesive (thickness: 5 μm) by the roll-to-roll process so that their conveying directions were parallel to each other. Thus, a polarizing plate with retardation layers (second retardation layer/first retardation layer/polarizer/TAC film) was obtained.

(Production of Prism Sheet)

A PET film (thickness: 100 μm) was used as a film for a base portion. A predetermined mold having arranged therein the PET film was filled with a UV-curable urethane acrylate resin as a material for a prism, and the material for a prism was cured by being irradiated with UV light. Thus, such a prism sheet as illustrated in each of FIGS. 1 and 3 was produced. The in-plane retardation Re of its base portion was 0 nm. Its unit prisms were triangular prisms, and the shape of a section of each of the unit prisms parallel to its arrangement direction and parallel to its thickness direction was a scalene triangle shape.

(Production of Light-Diffusing Pressure-Sensitive Adhesive Layer)

### Preparation of Acrylic Polymer

74.9 Parts of butyl acrylate, 20 parts of benzyl acrylate, 5 parts of acrylic acid, 0.1 part of 4-hydroxybutyl acrylate, and 0.1 part of 2,2′-azobisisobutyronitrile as a polymerization initiator, together with 100 parts of ethyl acetate (monomer concentration: 50%), were loaded into a four-necked flask provided with a stirring blade, a temperature gauge, a nitrogen gas-introducing tube, and a condenser. While the mixture was gently stirred, air in the flask was replaced with nitrogen by introducing a nitrogen gas. After that, the temperature of the liquid in the flask was kept at around 55° C. and a polymerization reaction was performed for 8 hours. Thus, a solution of an acrylic polymer having a weight-average molecular weight (Mw) of 2,040,000 and a molecular weight distribution Mw/Mn of 3.2 was prepared.

### Preparation of Light-Diffusing Pressure-Sensitive Adhesive Composition

100 Parts of the solid content of the acrylic polymer solution obtained in the foregoing were compounded with 0.45 part of an isocyanate cross-linking agent (CORONATE L manufactured by Nippon Polyurethane Industry Co., Ltd., adduct of trimethylolpropane with tolylene diisocyanate), 0.1 part of benzoyl peroxide (NYPER BMT manufactured by Nippon Oil & Fats Co., Ltd.), 0.1 part of a silane coupling agent (KBM403 manufactured by Shin-Etsu Chemical Co., Ltd.), and 26 parts of light-diffusible fine particles (TOSPEARL 130 manufactured by Momentive Performance Materials Inc., particle diameter: 3 μm). Thus, an acrylic light-diffusing pressure-sensitive adhesive composition was prepared. The refractive index of the resultant acrylic light-diffusing pressure-sensitive adhesive composition was 1.481.

### Formation of Light-Diffusing Pressure-Sensitive Adhesive Layer

Next, the acrylic light-diffusing pressure-sensitive adhesive composition was applied to one surface of a polyethylene terephthalate (PET) film having a thickness of 38 μm (MRF38 manufactured by Mitsubishi Chemical Polyester Film) subjected to silicone treatment so that the thickness of a pressure-sensitive adhesive layer after drying became 23 μm. The composition was subjected to drying treatment at 155° C. for 1 minute to form a light-diffusing pressure-sensitive adhesive layer.

(Production of Optical Member)

The polarizing plate with the retardation layers obtained in the foregoing and a reflective polarizer (manufactured by 3M Company, trade name: “DBEF-Q”, thickness: 110 μm) were bonded onto each other through the light-diffusing pressure-sensitive adhesive layer obtained in the foregoing. The polarizing plate integrated with the reflective polarizer and the reverse prism sheet obtained in the foregoing were bonded onto each other through an acrylic pressure-sensitive adhesive (23 μm). Thus, an optical member having such a construction “polarizing plate/light diffusion layer (light-diffusing pressure-sensitive adhesive layer)/reflective polarizer/prism sheet” as illustrated in FIG. 1 was obtained. It should be noted that the integration was performed so that the ridge line direction of each unit prism of the prism sheet and the transmission axis of the polarizing plate were perpendicular to each other, and the transmission axis of the polarizing plate and the transmission axis of the reflective polarizer were parallel to each other.

(Production of Liquid Crystal Display Apparatus)

A liquid crystal display panel was taken off from a liquid crystal display apparatus of the IPS mode (manufactured by Apple Inc., trade name: “iPad2”), and an optical member such as a polarizing plate was removed from the liquid crystal display panel to take off a liquid crystal cell. Both surfaces (outside of each glass substrate) of the liquid crystal cell were cleaned for use. A commercially available polarizing plate (manufactured by Nitto Denko Corporation, product name: “CVT1764FCUHC”) was bonded onto the upper side (viewer side) of the liquid crystal cell. Further, in order to improve visibility in viewing the liquid crystal display apparatus while wearing polarizing sunglasses, a λ/4 plate (manufactured by Kaneka Corporation, trade name: “UTZ film #140”) was bonded onto the polarizing plate in such a manner that its slow axis formed an angle of 45° with respect to the absorption axis of the polarizing plate. Further, the optical member obtained in the foregoing was bonded as a lower side (back surface side) polarizing plate to the lower side (back surface side) of the liquid crystal cell through an acrylic pressure-sensitive adhesive. Thus, a liquid crystal display panel was obtained. At this time, the bonding was performed so that the transmission axes of the respective polarizing plates were perpendicular to each other.

Meanwhile, a backlight unit of an edge light system was produced by assembling a plurality of point sources (LED light sources), a light guide plate, and a reflective sheet according to a construction typically used in the industry. The backlight unit was incorporated into the liquid crystal display panel obtained in the foregoing, so as to produce a liquid crystal display apparatus as illustrated in FIG. 4. The resultant liquid crystal display apparatus was subjected to the evaluations (1) to (5). Table 1 shows the results.

### Example 2

A liquid crystal display apparatus was produced in the same manner as in Example 1 except that the light-diffusible fine particles in the light-diffusing pressure-sensitive adhesive composition were changed to TOSPEARL 120 manufactured by Momentive Performance Materials Inc. (particle diameter: 2 μm). The resultant liquid crystal display apparatus was subjected to the evaluations (1) to (5). Table 1 shows the results.

### Example 3

A liquid crystal display apparatus was produced in the same manner as in Example 1 except that the light-diffusible fine particles in the light-diffusing pressure-sensitive adhesive composition were changed to TOSPEARL 145 manufactured by Momentive Performance Materials Inc. (particle diameter: 4 μm). The resultant liquid crystal display apparatus was subjected to the evaluations (1) to (5). Table 1 shows the results.

### Example 4

A liquid crystal display apparatus was produced in the same manner as in Example 1 except that: the usage amount of butyl acrylate in the preparation of the acrylic polymer was changed to 85.9 parts; and the usage amount of benzyl acrylate in the preparation was changed to 9 parts. The resultant liquid crystal display apparatus was subjected to the evaluations (1) to (5). Table 1 shows the results.

### Example 5

A liquid crystal display apparatus was produced in the same manner as in Example 4 except that the light-diffusible fine particles in the light-diffusing pressure-sensitive adhesive composition were changed to TOSPEARL 120 manufactured by Momentive Performance Materials Inc. (particle diameter: 2 μm). The resultant liquid crystal display apparatus was subjected to the evaluations (1) to (5). Table 1 shows the results.

### Example 6

A liquid crystal display apparatus was produced in the same manner as in Example 4 except that the light-diffusible fine particles in the light-diffusing pressure-sensitive adhesive composition were changed to TOSPEARL 145 manufactured by Momentive Performance Materials Inc. (particle diameter: 4 μm). The resultant liquid crystal display apparatus was subjected to the evaluations (1) to (5). Table 1 shows the results.

### Example 7

A liquid crystal display apparatus was produced in the same manner as in Example 1 except that: the usage amount of butyl acrylate in the preparation of the acrylic polymer was changed to 68.9 parts; and the usage amount of benzyl acrylate in the preparation was changed to 26 parts. The resultant liquid crystal display apparatus was subjected to the evaluations (1) to (5). Table 1 shows the results.

### Example 8

A liquid crystal display apparatus was produced in the same manner as in Example 7 except that the light-diffusible fine particles in the light-diffusing pressure-sensitive adhesive composition were changed to TOSPEARL 120 manufactured by Momentive Performance Materials Inc. (particle diameter: 2 μm). The resultant liquid crystal display apparatus was subjected to the evaluations (1) to (5). Table 1 shows the results.

### Example 9

A liquid crystal display apparatus was produced in the same manner as in Example 7 except that the light-diffusible fine particles in the light-diffusing pressure-sensitive adhesive composition were changed to TOSPEARL 145 manufactured by Momentive Performance Materials Inc. (particle diameter: 4 μm). The resultant liquid crystal display apparatus was subjected to the evaluations (1) to (5). Table 1 shows the results.

### Comparative Example 1

A liquid crystal display apparatus was produced in the same manner as in Example 1 except that the light-diffusible fine particles in the light-diffusing pressure-sensitive adhesive composition were changed to TOSPEARL 2000B manufactured by Momentive Performance Materials Inc. (particle diameter: 6 μm). The resultant liquid crystal display apparatus was subjected to the evaluations (1) to (5). Table 1 shows the results.

### Comparative Example 2

A liquid crystal display apparatus was produced in the same manner as in Example 1 except that a light-diffusing pressure-sensitive adhesive composition was prepared as described below. The resultant liquid crystal display apparatus was subjected to the evaluations (1) to (5). Table 1 shows the results.

94.9 Parts of butyl acrylate, 5 parts of acrylic acid, 0.1 part of 4-hydroxybutyl acrylate, and 0.1 part of 2,2′-azobisisobutyronitrile as a polymerization initiator, together with 100 parts of ethyl acetate (monomer concentration: 50%), were loaded into a four-necked flask provided with a stirring blade, a temperature gauge, a nitrogen gas-introducing tube, and a condenser. While the mixture was gently stirred, air in the flask was replaced with nitrogen by introducing a nitrogen gas. After that, the temperature of the liquid in the flask was kept at around 55° C. and a polymerization reaction was performed for 8 hours. Thus, a solution of an acrylic polymer having a weight-average molecular weight (Mw) of 2,020,000 and a molecular weight distribution Mw/Mn of 3.2 was prepared. 100 parts of the solid content of the acrylic polymer solution thus obtained were compounded with 0.45 part of an isocyanate cross-linking agent (CORONATE L manufactured by Nippon Polyurethane Industry Co., Ltd., adduct of trimethylolpropane with tolylene diisocyanate), 0.1 part of benzoyl peroxide (NYPER BMT manufactured by Nippon Oil & Fats Co., Ltd.), and 26 parts of light-diffusible fine particles (TOSPEARL 130 manufactured by Momentive Performance Materials Inc., particle diameter: 3 μm). Thus, an acrylic light-diffusing pressure-sensitive adhesive composition was prepared. The refractive index of the resultant acrylic light-diffusing pressure-sensitive adhesive composition was 1.468.

### Comparative Example 3

A liquid crystal display apparatus was produced in the same manner as in Comparative Example 2 except that the light-diffusible fine particles in the light-diffusing pressure-sensitive adhesive composition were changed to TOSPEARL 120 manufactured by Momentive Performance Materials Inc. (particle diameter: 2 μm). The resultant liquid crystal display apparatus was subjected to the evaluations (1) to (5). Table 1 shows the results.

### Comparative Example 4

A liquid crystal display apparatus was produced in the same manner as in Comparative Example 2 except that the light-diffusible fine particles in the light-diffusing pressure-sensitive adhesive composition were changed to TOSPEARL 145 manufactured by Momentive Performance Materials Inc. (particle diameter: 4 μm). The resultant liquid crystal display apparatus was subjected to the evaluations (1) to (5). Table 1 shows the results.

TABLE 1

| | Particle | | | | | |
|---|---|---|---|---|---|---|
| | diameter of | Refractive index of | | | | |
| | light-diffusible | pressure-sensitive | | | | |
| | fine particles | adhesive | Haze | | | Brightness |
| | (μm) | composition | (%) | Moire | Glare | (cd/m²) |
| Example 1 | 3 | 1.481 | 92.7 | ⊚ | ⊚ | ⊚ |
| Example 2 | 2 | 1.481 | 88.5 | ◯ | ⊚ | ⊚ |
| Example 3 | 4 | 1.481 | 90.2 | ⊚ | ◯ | ⊚ |
| Example 4 | 3 | 1.475 | 88.9 | ◯ | ⊚ | ⊚ |
| Example 5 | 2 | 1.475 | 86.1 | ◯ | ⊚ | ⊚ |
| Example 6 | 4 | 1.475 | 87.0 | ◯ | ◯ | ⊚ |
| Example 7 | 3 | 1.490 | 93.6 | ⊚ | ⊚ | ⊚ |
| Example 8 | 2 | 1.490 | 92.7 | ⊚ | ⊚ | ⊚ |
| Example 9 | 4 | 1.490 | 93.1 | ⊚ | ◯ | ⊚ |
| Comparative | 6 | 1.481 | 81.9 | ◯ | X | ⊚ |
| Example 1 | | | | | | |
| Comparative | 3 | 1.468 | 84.2 | X | ⊚ | ⊚ |
| Example 2 | | | | | | |
| Comparative | 2 | 1.468 | 71.8 | X | ⊚ | ⊚ |
| Example 3 | | | | | | |
| Comparative | 4 | 1.468 | 80.7 | X | ⊚ | ⊚ |
| Example 4 | | | | | | |

<Evaluation>

As is apparent from Table 1, the occurrence of the moire and the glare is satisfactorily prevented in the liquid crystal display apparatus of each of Examples of the present invention, and the apparatus has high brightness. On the other hand, the moire or the glare occurs in the liquid crystal display apparatus of each of Comparative Examples in which the particle diameter of the light-diffusible fine particles or the refractive index of the pressure-sensitive adhesive composition deviates from the range of the present invention.

### INDUSTRIAL APPLICABILITY

The optical member according to an embodiment of the present invention can be suitably used as a back surface side polarizing plate for a liquid crystal display apparatus. The liquid crystal display apparatus using such optical member can be used for various applications such as portable devices including a personal digital assistant (PDA), a cellular phone, a watch, a digital camera, and a portable gaming machine, OA devices including a personal computer monitor, a notebook-type personal computer, and a copying machine, electric home appliances including a video camera, a liquid crystal television set, and a microwave oven, on-board devices including a reverse monitor, a monitor for a car navigation system, and a car audio, exhibition devices including an information monitor for a commercial store, security devices including a surveillance monitor, and caring/medical devices including a caring monitor and a medical monitor.

### REFERENCE SIGNS LIST

10 polarizing plate
11 polarizer
12 protective layer
13 protective layer
20 light-diffusing pressure-sensitive adhesive layer
30 reflective polarizer
40 prism sheet
41 base portion
42 prism portion
100 optical member

1. An optical member, comprising:
a polarizing plate;
a light-diffusing pressure-sensitive adhesive layer;
a reflective polarizer; and
a prism sheet,
wherein:
a volume-average particle diameter of light-diffusible fine particles in the light-diffusing pressure-sensitive adhesive layer is from 1 μm to 4 μm; and
a refractive index of a pressure-sensitive adhesive in the light-diffusing pressure-sensitive adhesive layer is 1.47 or more.

2. The optical member according to claim 1, wherein the light-diffusing pressure-sensitive adhesive layer has a haze value of from 80% to 95%.

3. The optical member according to claim 1, wherein the pressure-sensitive adhesive contains a (meth)acrylic polymer containing an alkyl(meth)acrylate, an aromatic ring-containing (meth)acrylic monomer, a carboxyl group-containing monomer, and a hydroxyl group-containing monomer as monomer units.

4. The optical member according to claim 1, wherein an air layer is absent between the polarizing plate and the prism sheet.

5. The optical member according to claim 1, wherein the optical member comprises a polarizing plate integrated with the prism sheet.

6. A polarizing plate set, comprising:
the optical member according to claim 1 to be used as a back surface side polarizing plate; and
a viewer side polarizing plate.

7. A liquid crystal display apparatus, comprising:
a liquid crystal cell;
a polarizing plate arranged on a viewer side of the liquid crystal cell; and
the optical member according to claim 1 arranged on a side of the liquid crystal cell opposite to the viewer side,
wherein a distance between opposing black matrices in one pixel of the liquid crystal cell is 200 μm or less.
